(19) United States
(12) Patent Application Publication
(10) Pub. No.: US 2006/0182140 A1
(43) Pub. Date: Aug. 17, 2006

(54) Method and apparatus to facilitate forwarding of single frame and multi-frame data packets

(75) Inventors: Devarajan Puthupparambil, Mt. Prospect, IL (US); J. Schneider, Grayslake, IL (US)

Correspondence Address: FITCH EVEN TABIN AND FLANNERY, 120 SOUTH LA SALLE STREET, SUITE 1600, CHICAGO, IL, 60603-3406, US

(73) Assignee: UTStarcom, Inc.

(21) Appl. No.: 11/058,139

(22) Filed: Feb. 15, 2005

(51) Int. Cl. H04J 3/22

(52) U.S. Cl. 370/465; 370/401

(57) ABSTRACT

An apparatus (50), such as a transaction gateway, receives (11) a communication that corresponds to one or more transactions. This communication comprises at least one data packet that may comprise either a single data frame or a plurality of data frames as correspond to such a transaction. When the data packet comprises only a single data frame, a first course of action is taken (13). When the data packet comprises a plurality of data frames, a second course of action is taken (14). In a preferred approach, the second course of action comprises, at least in part, converting (33) the data packet into a plurality of data packets that each comprise only an individual data frame.

### TECHNICAL FIELD

This invention relates generally to data packet forwarding, and more particularly to the handling of data packets comprising a single frame of transaction data and data packets comprising a plurality of frames of transaction data.

### BACKGROUND

The processing of transaction data comprises a well-understand area of endeavor. For example, various mechanisms and protocols exist to facilitate the exchange of transaction information as between point-of-sale terminals and a corresponding credit card acquirer's host server(s). The VISA International Acquirer Services External Interface Specification (2^{nd} generation) is illustrative (and in particular the Authorization Link Level Protocol EIS 1051 Version 3.0 as comprises a part thereof) in this regard. In general, such elements exchange transaction data (such as, but not limited to, transaction requests and corresponding responses) by exchanging data packets that each comprise a sole individual data frame. Pursuant to the VISA 1051 protocol, each such frame is characterized by a Start-of-Frame (STX) character at the beginning of the data frame and an End-of-Frame (ETX) character at the conclusion of the data frame, with the transaction information itself falling there between. This convention applies to both single and multi-threaded modes of operation.

In at least some cases such network elements are otherwise capable of, or could be made to be capable of, forming multi-frame data packets to convey such data. In general, however, such capability remains unused due to a likelihood of incompatible reception by incapable target recipients and the consequences of such incompatibility. In particular, incompatible processing of a multi-frame data packet bearing such transaction data will typically result in the first data frame being properly processed and all subsequent data frames in that shared data packet being essentially ignored (that is, such subsequent data frames are neither acknowledged and used nor negatively acknowledged to encourage their retransmission).

### BRIEF DESCRIPTION OF THE DRAWINGS

The above needs are at least partially met through provision of the method and apparatus to facilitate forwarding of single frame and multi-frame data packets described in the following detailed description, particularly when studied in conjunction with the drawings, wherein:

FIG. 1 comprises a flow diagram as configured in accordance with various embodiments of the invention;

FIG. 2 comprises a flow diagram as configured in accordance with various embodiments of the invention;

FIG. 3 comprises a flow diagram as configured in accordance with various embodiments of the invention;

FIG. 4 comprises a flow diagram as configured in accordance with various embodiments of the invention;

FIG. 5 comprises a block diagram as configured in accordance with various embodiments of the invention;

FIG. 6 comprises a signal flow diagram as configured in accordance with various embodiments of the invention; and

FIG. 7 comprises a signal flow diagram as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the arts will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, one receives a communication as corresponds to at least one transaction, wherein the communication comprises at least one data packet and which is directed to a target recipient (such as a point-of-sale platform or a host server platform). One then takes a first course of action to effect forwarding of that data packet(s) to the target recipient when the at least one data packet comprises an individual data frame, and a second course of action to effect forwarding of that data packet(s) to the target recipient when the at least one data packet comprises a plurality of data frames (wherein the second course of action is different than the first course of action). In a preferred approach, the second course of action comprises, at least in part, conversion of the multi-frame data packet into a plurality of data packets that each comprise an individual data frame. So configured, transaction information can be initially transmitted using a multi-frame data packet approach and can then be compatibly provided to target recipients that are not otherwise able to properly process information in such a format.

In a preferred approach, one can supplement this approach by determining, upon receiving a multi-frame data packet, whether the corresponding target recipient can likely compatibly process such a data packet. When true, such parsing of the various frames that comprise the data packet may be avoided and the data packet forwarded in that multi-frame format to the target recipient. When false, however, the above-described parsing can be employed to ensure compatible reception of the transaction information by the target recipient.

Those skilled in the art will appreciate that these teachings are readily employed with either a relatively real-time process or with deferred batch transmissions (with both techniques being relatively common in the art of conveying transaction data between various network elements).

So configured, multi-frame data packet techniques are more readily deployed in conjunction with existing legacy transaction facilitation systems such as those that employ the aforementioned VISA EIS 1051 Authorization Link Level Protocol without requiring a re-design or retrofitting of the various network elements that comprise an overall system. This, in turn, permits improved communications efficiency in many instances which can lead to improved system performance.

These and other benefits may become clearer upon making a thorough review and study of the following detailed description. Referring now to the drawings, and in particular to FIG. 1, a suitable network element, such as a transaction gateway, can effect such teachings via the depicted process 10. Such a platform receives 11 a communication as corresponds to at least one transaction (such as a point-of-sale transaction), which communication might comprise, for example, at least one data packet and which communication is preferably directed to a target recipient. To illustrate, a point-of-sale terminal might be seeking to provide transaction request and/or response data to a host server or vice versa. The platform then determines 12 whether this data packet (or these data packets) comprises only a single data frame or a plurality of data frames.

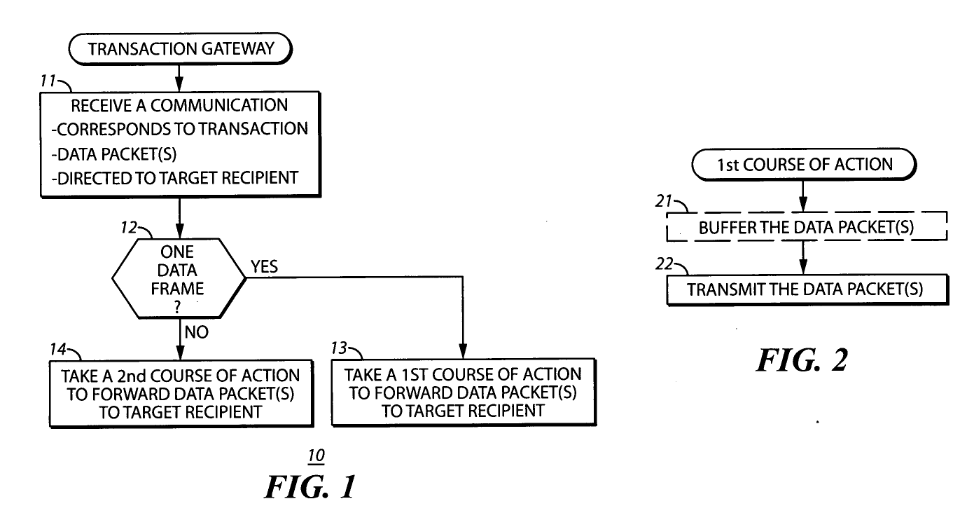

When the data packet comprises only a single individual data frame, the platform takes 13 a first course of action to effect the forwarding of this data packet to the target recipient. For example, and referring momentarily to FIG. 2, this platform may, in an optional approach, buffer 21 the data packet(s) that comprises only a single data frame, either in general or as are directed to a particular predetermined recipient. In any event, this platform then, either in relative real time or at some appropriate time after having buffered such information, transmits 22 these one data frame data packets to their respective target recipients to effect their proper forwarding. So configured, this process 10 readily accommodates ordinary processing of present day data packets that only comprise a single individual data frame of transaction data.

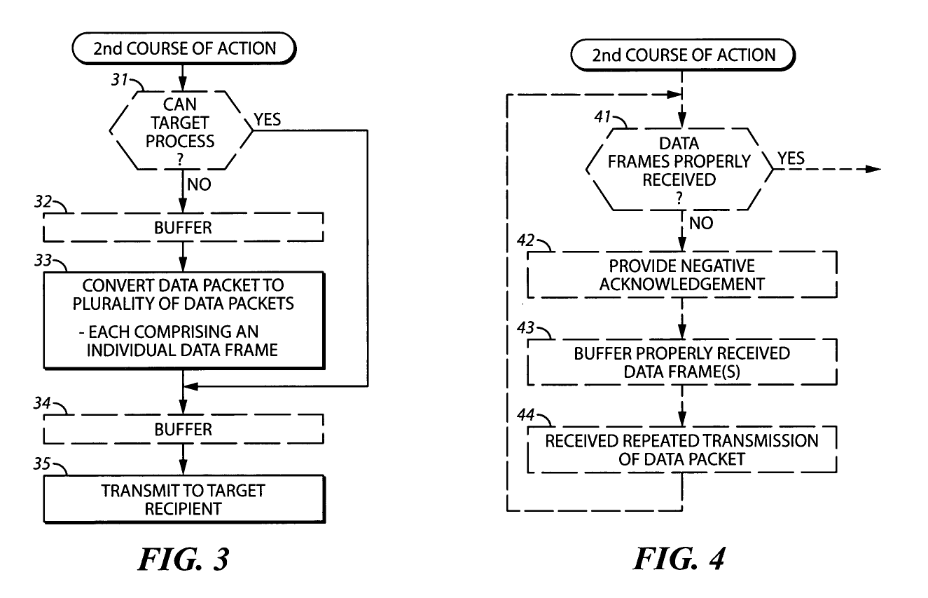

Referring again to FIG. 1, when the data packet in question comprises a plurality of such data frames, the enabling platform takes 14 a second course of action to forward at least some of the data packets to the indicated target recipient, which second course of action is different than the first course of action. For example, and with reference now to FIG. 3, the second course of action can optionally comprise making a determination 31 regarding whether the indicated target recipient for a given multi-frame data packet can likely compatibly process a multi-frame data packet. Such a determination can be effected in various ways, including but not limited to:
making a present query of the target recipient with respect to this capability;
transmitting the present multi-frame data packet to the target recipient and then monitoring whether that target recipient provides a corresponding acknowledgement for each of the frames that comprises that data packet;
accessing a local or remote table, database, or other resource as contains such information;
processing an indication regarding this target recipient capability as might have been provided in the communication that delivered the multi-frame data packet or that was transmitted in conjunction with such a communication;
to name a few.

When true, meaning that the target recipient can indeed likely properly and fully process a multi-frame data packet, the second course of action can proceed as described further below to effect optional buffering of the transaction data and eventual if not relatively immediate transmission of the content to the target recipient.

When not true, however, the second course of action can effect the following described steps. In some cases, the overall transaction data handling process may comprise a batch process. In such a case, the host server will typically only expect to handle (or may only be available to handle) an exchange of transaction data during a given window of time (such as late at night following store closures). To accommodate such batch processing, the second course of action can optionally include a buffering capability 32 to permit buffering of the multi-frame data packets prior to any further processing. Such buffered content can then be unbuffered and processed as follows at the appropriate time in accordance with well-understood prior art technique.

Whether provided in relative real time or following such buffering, the second course of action acts, at least in part, to convert the data packet(s) into a plurality of non-redundant data packets and, preferably, into a plurality of data packets that each comprise an individual data frame. In effect, the second course of action converts a multi-frame data packet into a plurality of corresponding individual-frame data packets as typifies present protocols and practice regarding the exchange of transaction information.

As mentioned above, the overall process may comprise a batch process. In such a case, and particularly where the second course of action did not effect the earlier described buffering action 32, one can optionally provide for the buffering 34 of this plurality of individual-frame data packets pending their scheduled time of transmission. In any event, whether delayed by buffering or not, this second course of action also provides for transmission 35 of these individual-frame data packets to the corresponding target recipient.

The above described teachings serve, as will be understood by those skilled in the art, to receive, process (or not process) as appropriate, and then forward a data packet that may comprise either an individual data frame of transaction information or multiple data frames of such information. These teachings are readily applicable to transmissions as are sourced by a point-of-sale platform and to transmissions as are sourced by a transactions host server.

It is possible, however, that a given transmission as received by the enabling platform will contain errors and/or present other issues with respect to accurately recovering and/or forwarding the original transaction action. Present protocols (such as the VISA 1051 protocol) provide for error detection and correction but only with a presumption that a given data packet contains a single data frame of interest. If a given data packet as received by a transaction gateway contains, for example, a correctly received first data frame and an incorrectly received second data frame, present practice makes no provision for either determining this status of the second data frame or for correcting this situation; only the first data frame will be processed with respect to error detection/correction.

To address this concern, and referring now to FIG. 4, the second course of action can further optionally provide for a determination 41 regarding whether each data frame of a plurality of data frames was properly received, even when those data frames share a common data packet. When all of the data frames have been properly received, the process can simply continue as described above. When at least one of the data frames has not been properly received, however, the transaction gateway can provide 42 a negative acknowledgement to the element that sourced the transmission to indicate that at least one of the data frames was not properly received. If desired, this can simply comprise a present-practice negative acknowledgement which, when received by the sourcing element, will cause the latter to retransmit the entire original multi-data frame data packet.

Pursuant to one optional approach, the second course of action can then buffer 43 the properly received data frame (or frames). Upon then receiving 44 the expected repeated transmission of the corresponding data packet, this process can proceed as described above; when a determination 41 can be made that all data frames as comprise a given data packet have been properly received, the second course of action can then continue as described above to convert the data packet into a plurality of individual data frame data packets.

Those skilled in the art will appreciate that other techniques can be pursued if desired. For example, rather than buffering properly received data frames while awaiting proper reception of all of the data frames as comprise an individual data packet, the second course of action can instead effect an immediate transmission of all properly received data frames even prior to receiving the expected retransmission of the complete data packet.

So configured, multi-frame data packet transmissions can not only be properly processed and parsed to ensure compatible reception and handling by an ultimate target recipient but can also be error detected and corrected in a manner that is compatible with present protocols, notwithstanding that such present protocols do not anticipate the use of multi-frame data packets when conveying transaction data.

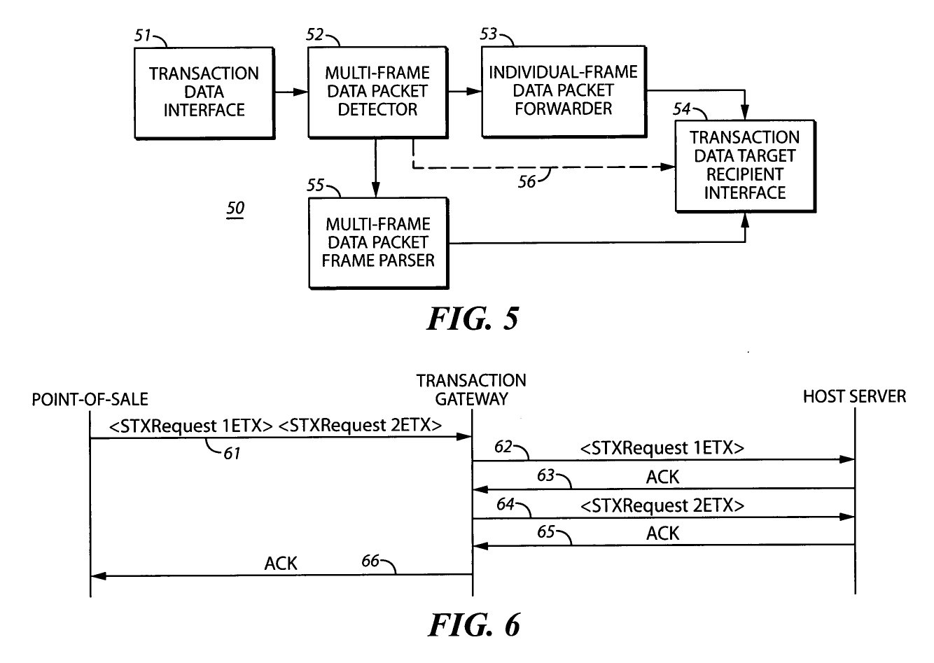

Those skilled in the art will appreciate that these teachings can be effected through various physical embodiments. An illustrative example appears in FIG. 5, wherein a transaction gateway 50 may preferably comprise a transaction data interface 51 (to facilitate the reception of single-frame and multi-frame data packets that are to be forwarded on to a target recipient) and a transaction data target recipient interface 54 (to facilitate the forwarding of data packets to their corresponding target recipients). These interfaces 51 and 54 may comprise a wireless or a wired interface and may be compatible or otherwise interoperable with any appropriate communications protocol as may be presently used or hereafter developed.

In a preferred embodiment the transaction gateway 50 further comprises a multi-frame data packet detector 52 that serves to detect and differentiate as between data packets that comprise a single data frame and those that comprise a plurality of data frames. This detector 52 is preferably operably coupled to an individual-frame data packet forwarder 53 that further operably couples to the transaction data target recipient interface 54. This detector 52 is also preferably operably coupled to a multi-frame data packet frame parser 55 that also operably couples to the transaction data target recipient interface 54. So configured, the multi-frame data packet detector 52 will divert and direct individual-frame data packets to the individual-frame data packet forwarder 53 to facilitate their transmission and forwarding to the target recipient via the transaction data target recipient interface. Similarly, the multi-frame data packet detector 52 will divert and direct multi-frame data packets to the multi-frame data packet frame parser 55 where those multi-frame data packets are parsed as described above. Those resultant individual-frame data packets are then provided to the transaction data target recipient interface 54 where again they are forwarded in ordinary course to the proper target recipient.

If desired, and where the multi-frame data packet detector 52 (or such other control entity as may be selected and applied) is able to determine that a received multi-frame data packet can be compatibly received and processed by a given target recipient, if may also be desirable to provide an operable interconnection 56 between the multi-frame data packet detector 52 and the transaction data target recipient interface 54 to permit the forwarding of those multi-frame data packets in their present form.

So configured and arranged, the transaction gateway 50 comprises an apparatus that is capable of receiving a communication as corresponds to at least one transaction, wherein the communication comprises at least one data packet and which communication is directed to a target recipient. This apparatus is then capable, when the at least one data packet comprises an individual data frame, of effecting a first course of action to effect forwarding of the at least one data packet to the target recipient. This apparatus is then also capable, when the at least one data packet comprises a plurality of data frames, of effecting a second, different course of action to effect forwarding of the at least one data packet to the target recipient. In a preferred approach, this second course of action comprises, at least in part, converting the data packet (or packets) into a plurality of data packets that each comprise an individual data frame.

If desired, various of these elements of such an apparatus can be provided with buffering capabilities to permit buffering of their corresponding data in order to facilitate and support batch processing procedures as may be desired or preferred by a given system operator.

So configured, these teachings are readily applicable for use in protocol scenarios that do not otherwise support multi-frame data packets. As a first example of such compatible operation, and referring now to FIG. 6, a point-of-sale element can source a two-frame data packet 61 containing transaction data. The first data frame can be begin with the STX character and end with the ETX character as required by the VISA 1051 protocol and can comprise transaction data as embodied in a “Request 1.” In similar fashion the second data frame can also begin with the STX character and conclude with the ETX character and can comprise “Request 2” transaction information.

Upon receiving this data packet 61, the transaction gateway, upon optionally determining that the host server identified as the target recipient is not likely capable of properly receiving and processing such a multi-frame data packet, can parse these data frames as described above. The first data frame can then be transmitted as a discrete data packet 62 while the second data frame is transmitted as a separate discrete data packet 64. In accord with VISA 1051 protocol, the receiving host server will respond to each such transmission with a corresponding acknowledgement (ACK) 63 and 65. Upon receiving these acknowledgements, the transaction gateway can then provide a single acknowledgement 66 to the point-of-sale element to indicate successful reception of the initial data packet by the host server.

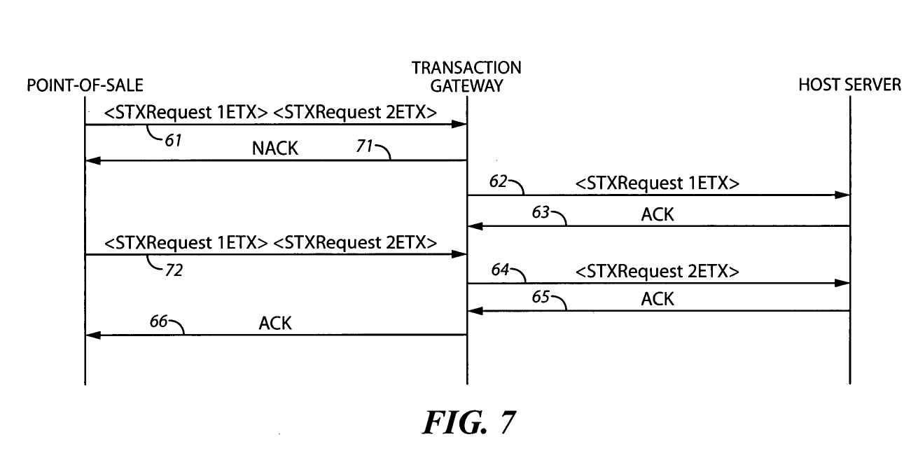

As a second example of such compatible operation, and referring now to FIG. 7, upon receiving such a multi-frame data packet 61 as described above, and upon determining that the second data frame in that data packet 61 was not properly received, the transaction can transmit a negative acknowledgement (NAK) 71 to the source point-of-sale element while also, if desired, forwarding the parsed properly received first data frame 62 to the target recipient which again provides an acknowledgement 63 to the transaction gateway upon receiving this transmission. The point-of-sale element, in response to having receiving the negative acknowledgement 71, retransmits the multi-frame data packet 72 to the transaction gateway. In this illustrative example, the transaction gateway now properly receives the second data frame and forwards that second data frame 64 as a parsed individual data packet to the host server. The latter than acknowledges 65 this second transmission and the transaction gateway then acknowledges 66 reception of the complete multi-frame data packet to the point-of-sale platform.

Pursuant to these teachings, a transaction data system and protocol that otherwise does not accommodate multiple frames of transaction data in a single data packet can now facilitate the compatible handling of such data packets by network elements that are configured to source and/or receive such content. This in turn provides an opportunity for improved system operations in a rolling fashion that does not require a change-out of all system elements at a common time.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A method comprising:
receiving a communication as corresponds to at least one transaction, wherein the communication comprises at least one data packet and which communication is directed to a target recipient;
when the at least one data packet comprises an individual data frame, taking a first course of action to effect forwarding the at least one data packet to the target recipient;
when the at least one data packet comprises a plurality of data frames, taking a second course of action to effect forwarding the at least one data packet to the target recipient, which second course of action is different than the first course of action.

2. The method of claim 1 wherein taking a first course of action further comprises forwarding the at least one data packet to the target recipient.

3. The method of claim 1 wherein taking a second course of action further comprises converting the data packet into a plurality of non-redundant data packets.

4. The method of claim 3 wherein converting the data packet into a plurality of non-redundant data packets further comprises converting the data packet into a plurality of data packets that each comprise an individual data frame.

5. The method of claim 1 wherein taking a second course of action further comprises determining whether the target recipient can likely compatibly process a multi-frame data packet.

6. The method of claim 1 wherein:
the first course of action comprises:
buffering the at least one data packet to provide a buffered data packet;
batch transmitting the buffered data packet;
the second course of action comprises:
buffering information as corresponds to the at least one data packet to provide buffered information;
batch transmitting the buffered information as a plurality of one data frame data packets.

7. The method of claim 1 wherein the at least one transaction corresponds to a point-of-sale transaction.

8. The method of claim 1 wherein the second course of action comprises, in part:
determining that each of the plurality of data frames was properly received;
providing a negative acknowledgement to indicate when at least one of the plurality of data frames was not properly received.

9. The method of claim 8 wherein the second course of action further comprises, when at least one of the plurality of data frames was not properly received:
receiving, in response to providing the negative acknowledgement, a repeated transmission of the at least one data packet.

10. An apparatus comprising:
means for receiving a communication as corresponds to at least one transaction, wherein the communication comprises at least one data packet and which communication is directed to a target recipient;
means for, when the at least one data packet comprises an individual data frame, taking a first course of action to effect forwarding the at least one data packet to the target recipient;
means for, when the at least one data packet comprises a plurality of data frames, taking a second course of action to effect forwarding the at least one data packet to the target recipient, which second course of action is different than the first course of action.

11. The apparatus of claim 10 wherein the means for taking a first course of action further comprises means for forwarding the at least one data packet to the target recipient.

12. The apparatus of claim 10 wherein the means for taking a second course of action further comprises means for converting the data packet into a plurality of non-redundant data packets.

13. The apparatus of claim 12 wherein the means for converting the data packet into a plurality of non-redundant data packets further comprises means for converting the data packet into a plurality of data packets that each comprise an individual data frame.

14. The apparatus of claim 10 wherein the means for taking a second course of action further comprises means for determining whether the target recipient can likely compatibly process a multi-frame data packet.

15. The apparatus of claim 10 wherein:
the means for taking a first course of action comprises:
means for buffering the at least one data packet to provide a buffered data packet;
means for batch transmitting the buffered data packet;
the means for taking a second course of action comprises:
means for buffering information as corresponds to the at least one data packet to provide buffered information;
means for batch transmitting the buffered information as a plurality of one-data frame data packets.

16. The apparatus of claim 10 wherein the apparatus comprises a transaction gateway.

17. An apparatus comprising:
at least one transaction data interface;
at least one transaction data target recipient interface;
an individual-frame data packet forwarder having an input operably coupled to the transaction data interface and an output operably coupled to the transaction data target recipient interface;
a multi-frame data packet frame parser having an input operably coupled to the transaction data interface and an output operably coupled to the transaction data target recipient interface.

18. The apparatus of claim 17 and further comprising a multi-frame data packet detector having an input operably coupled to the transaction data interface and an output operably coupled to the input of the multi-frame data packet frame parser.

19. The apparatus of claim 18 wherein the multi-frame data packet parser further comprises means for converting a multi-frame data packet as received at the transaction data interface into a plurality of non-redundant data packets.

20. The apparatus of claim 19 wherein the non-redundant data packets each comprise an individual data frame.
